(19) United States
(12) Patent Application Publication
(10) Pub. No.: US 2017/0199310 A1
(43) Pub. Date: Jul. 13, 2017

(54) DIFFRACTIVE OPTICAL ELEMENT

(71) Applicant: NALUX CO., LTD., Osaka (JP)

(72) Inventor: Masato OKANO, Osaka (JP)

(21) Appl. No.: 15/471,426

(22) Filed: Mar. 28, 2017

Related U.S. Application Data
(63) Continuation of application No. PCT/JP2015/064619, filed on May 21, 2015.

(51) Int. Cl. G02B 5/18

(52) U.S. Cl. CPC G02B 5/1861

(57) ABSTRACT

A diffractive optical element according to the present invention forms a predetermined image with a parallel light beam at a predetermined angle of incidence and that has a grating having plural values of grating period. In the diffractive optical element, at least one of height of the grating and a ratio of grating groove width to grating period is changed as a function of grating period such that zeroth order efficiency is reduced.

### CROSS REFERENCE TO RELATED APPLICATION

This is a Continuation of International Patent Application No. PCT/JP2015/064619 filed May 21, 2015, which designates the U.S. The content of this application is hereby incorporated by reference.

### TECHNICAL FIELD

The present invention relates to a diffractive optical element in which zeroth order efficiency is reduced.

### BACKGROUND ART

A diffractive optical element that forms a desired diffraction image on a projection screen by generating diffracted lights of desired orders from the incident light has been developed. Such a diffractive optical element is used in a diffuser, a pattern generator, a beam shaper, a motion capture and the like installed in illumination devices, optical communication devices, and detectors.

In a diffractive optical element, it is desirable to maximize diffraction efficiency as well as to minimize zeroth order efficiency. The diffraction efficiency is a ratio of the energy of a predetermined order diffracted light to the energy of the incident light. Moreover, the zeroth order efficiency is a ratio of the energy of light that is normally incident on the plane of incidence and travels in a straight line without being diffracted to the energy of the incident light.

In conventional diffractive optical elements, zeroth order efficiency becomes great particularly when diffraction angle is great, and this causes a problem. In order to solve this problem, an optical system in which the zeroth order light generated in a first diffractive optical element is made to enter a second diffractive optical element has been developed (Patent Document 1). However, such an optical system is complicated in structure, because it uses two diffractive optical elements. Further, the design is intricate, because a diffractive image is formed through two diffractive optical elements.

Conventionally, a diffractive optical element that has a simple structure and that can reduce zeroth order efficiency has not been developed.

### PATENT DOCUMENT

Patent document 1: WO2009/093228

Accordingly, there is a need for a diffractive optical element that has a simple structure and that can reduce zeroth order efficiency.

### SUMMARY OF INVENTION

A diffractive optical element according to the present invention forms a predetermined image with a parallel light beam at a predetermined angle of incidence and that has a grating having plural values of grating period. In the diffractive optical element, at least one of height of the grating and a ratio of grating groove width to grating period is changed as a function of grating period such that zeroth order efficiency is reduced.

In the diffractive optical element according to the present invention, zeroth order efficiency can be reduced by changing at least one of height of the grating and a ratio of grating groove width to grating period as a function of grating period.

In a diffractive optical element according to a first embodiment of the present invention, the grating has N levels, N being an integer that is 2 or more, and height h of the grating is changed as a function of grating period, and when wavelength of the light is represented as A, the maximum value of h is represented as hmax, refractive index of the material of the grating is represented as n, and refractive index of the medium surrounding the grating is represented as no,

$$\frac{N - 1}{N} \cdot \frac{λ}{\vert n - {n}_{0} \vert} \leq h \leq h max$$

$$and$$

$$1.1 \cdot \frac{N - 1}{N} \cdot \frac{λ}{\vert n - {n}_{0} \vert} \leq h max \leq 2 \cdot \frac{N - 1}{N} \cdot \frac{λ}{\vert n - {n}_{0} \vert}$$

are satisfied.

In the diffractive optical element according to the present embodiment, zeroth order efficiency can be reduced by changing height of the grating depending on value of grating period.

In a diffractive optical element according to a second embodiment of the present invention, when an average value of height of the grating in the range of grating period that is greater than the lower limit period for generation of the third order reflected light and is equal to or smaller than the lower limit period for generation of the fifth order reflected light is represented as hav1, and an average value of height of the grating in the range of grating period that is greater than the lower limit period for generation of the fifth order reflected light and is equal to or smaller than the lower limit period for generation of the seventh order reflected light is represented as hav2,

$$\frac{N - 1}{N} \cdot \frac{λ}{\vert n - {n}_{0} \vert} < hav 2 < hav 1 < h max$$

is satisfied.

In the diffractive optical element according to the present embodiment, the above-described relationship is satisfied, and therefore zeroth order efficiency can be reduced in the range of grating period that is equal to or smaller than the lower limit period for generation of the seventh order reflected light and in the range of grating period that is equal to or smaller than the lower limit period for generation of the fifth order reflected light.

A diffractive optical element according to a third embodiment of the present invention, is the diffractive optical element according to the second embodiment wherein

$$0.03 \cdot \frac{N - 1}{N} \cdot \frac{λ}{\vert n - {n}_{0} \vert} \leq ( h max - hav 1 )$$

is satisfied.

In a diffractive optical element according to a fourth embodiment of the present invention, when a ratio of grating groove width to grating period is represented as F,

0.4≦F≦0.7

is satisfied.

In a diffractive optical element according to a fifth embodiment of the present invention, when a ratio of grating groove width to grating period is represented as F and the maximum value of F is represented as Fmax, F is changed as a function of grating period, and

0.5≦F≦F max

and

0.55≦F max≦0.7

are satisfied.

In the diffractive optical element according to the present embodiment, zeroth order efficiency can be reduced by changing the ratio F of grating groove width to grating period as a function of grating period.

In a diffractive optical element according to a sixth embodiment of the present invention, when an average value of a ratio of grating groove width to grating period in the range of grating period that is greater than the lower limit period for generation of the third order reflected light and is equal to or smaller than the lower limit period for generation of the fifth order reflected light is represented as Fav1, and an average value of a ratio of grating groove width to grating period in the range of grating period that is greater than the lower limit period for generation of the fifth order reflected light and is equal to or smaller than the lower limit period for generation of the seventh order reflected light is represented as Fav2,

0.5<Fav2<Fav1<F max

is satisfied.

In the diffractive optical element according to the present embodiment, the above-described relationship is satisfied, and therefore zeroth order efficiency can be reduced in the range of grating period that is equal to or smaller than the lower limit period for generation of the seventh order reflected light.

In a diffractive optical element according to a seventh embodiment of the present invention,

0.03≦(F max−Fav1)

is satisfied.

In a diffractive optical element according to an eighth embodiment of the present invention, the grating has N levels, N being an integer that is 2 or more, and when wavelength of the light is represented as λ, refractive index of the material of the grating is represented as n, refractive index of the medium surrounding the grating is represented as n₀ and height of the grating is represented as h,

$$0.08 \cdot \frac{N - 1}{N} \cdot \frac{λ}{\vert n - {n}_{0} \vert} \leq h \leq 2 \cdot \frac{N - 1}{N} \cdot \frac{λ}{\vert n - {n}_{0} \vert}$$

is satisfied.

### BRIEF DESCRIPTION OF DRAWINGS

FIG. 1 is a conceptual diagram for illustrating a general diffractive optical element;

FIG. 2 shows an example of a plan view of the diffractive optical element;

FIG. 3 is a conceptual diagram showing a portion along the straight line A-A′ in FIG. 2;

FIG. 4 shows an example of a diffraction image formed by the diffractive optical element on the projection plane;

FIG. 5 is a conceptual diagram showing a cross section of a conventional diffraction grating in the direction in which the grating is aligned;

FIG. 6 is a conceptual diagram showing a cross section of another conventional diffraction grating in the direction in which the grating is aligned;

FIG. 7 shows a relationship between grating period and zeroth order efficiency of a conventional diffractive optical element;

FIG. 8 shows a relationship between grating period and zeroth order reflection efficiency of the conventional diffractive optical element;

FIG. 9 is a conceptual diagram showing a cross section of a diffraction grating in a certain direction, height of the grating being changed depending on grating period;

FIG. 10 is another conceptual diagram showing a cross section of a diffraction grating in a certain direction, height of the grating being changed depending on grating period;

FIG. 11 is another conceptual diagram showing a cross section of a diffraction grating in a certain direction, height of the grating being changed depending on grating period;

FIG. 12 shows relationships between grating period, zeroth order efficiency and height of grating of a diffractive optical element of Example 1;

FIG. 13 shows relationships between grating period, zeroth order reflection efficiency and height of grating of the diffractive optical element of Example 1;

FIG. 14 shows relationships between diffraction angle, zeroth order efficiency and height of grating of the diffractive optical element of Example 1;

FIG. 15 is a section view of a grating for illustrating the ratio F of grating groove width to grating period;

FIG. 16 shows relationships between grating period, zeroth order efficiency and ratio F of a diffractive optical element of Example 2;

FIG. 17 shows relationships between diffraction angle, zeroth order efficiency and ratio F of the diffractive optical element of Example 2;

FIG. 18 shows relationships between grating period, zeroth order efficiency and height of grating of a diffractive optical element of Example 3;

FIG. 19 shows relationships between diffraction angle, zeroth order efficiency and ratio F of the diffractive optical element of Example 3; and

FIG. 20 illustrates behavior of higher order reflected light in a grating ridge.

### DESCRIPTION OF EMBODIMENTS

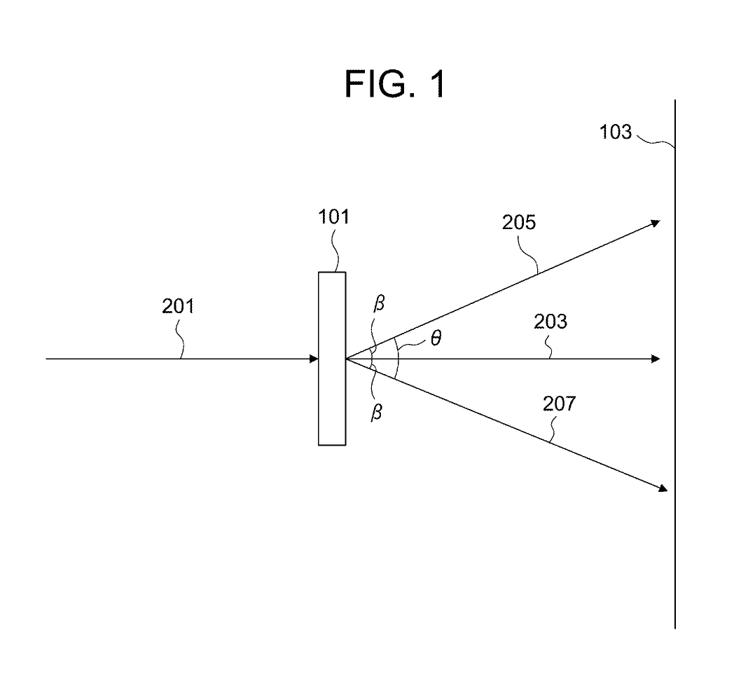

FIG. 1 is a conceptual diagram for illustrating a general diffractive optical element. Parallel rays 201 of a predetermined wavelength are normally incident on the entry side surface of a diffractive optical element 101. The parallel rays 201 are diffracted and exit from the exit side surface of the diffractive optical element 101 as the plus first order diffracted light 205, the minus first order diffracted light 207 and the zeroth order light 203. The plus first order diffracted light 205 and the minus first order diffracted light 207 are symmetric with respect to the zeroth order light 203 that is parallel to a normal to the exit side surface. In other words, an angle that the plus first order diffracted light 205 forms with the normal to the exit side surface is equal to an angle that the minus first order diffracted light 207 forms with the normal. The angle that the plus first order diffracted light 205 and the minus first order diffracted light 207 form with the normal to the exit side surface is referred to as a diffraction angle and represented as β. Diffraction images are formed on a projection plane 103 by the plus first order diffracted light 205 and the minus first order diffracted light 207. Although high order diffracted lights such as the plus and minus second order diffracted lights, the plus and minus third order diffracted lights, and the like and reflected lights are generated by the diffractive optical element 101, they are not shown in the drawing.

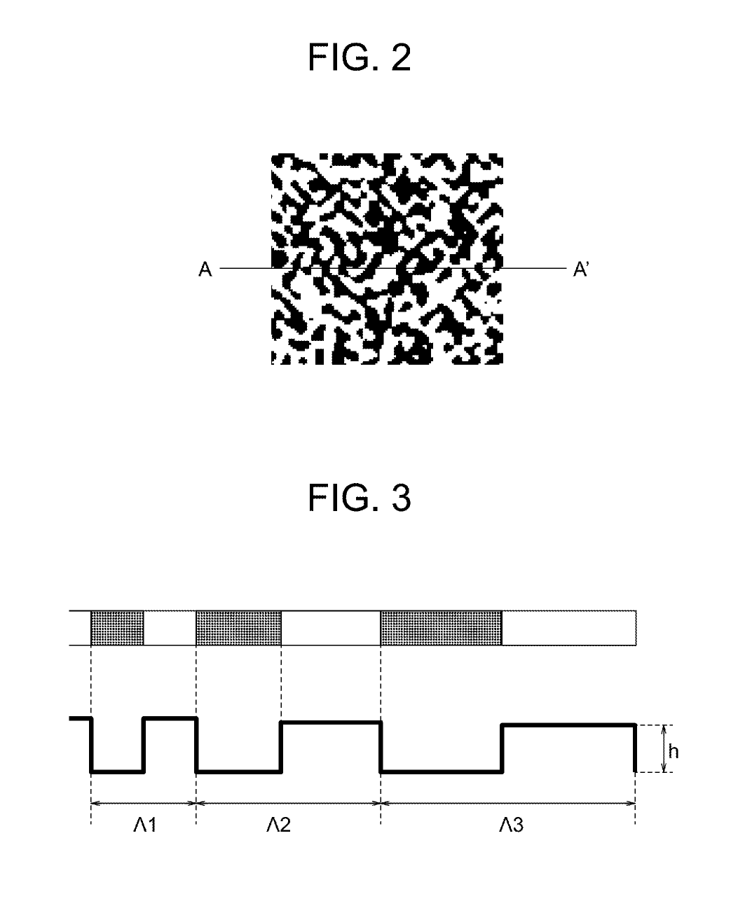

FIG. 2 shows an example of a plan view of the diffractive optical element 101. In FIG. 2, black portions represent grating grooves, and the white portions represent grating ridges.

FIG. 3 is a conceptual diagram showing a portion along the straight line A-A′ in FIG. 2. The portion along the straight line A-A′ includes a grating with three values of grating period Λ1, Λ2 and Λ3, for example. In general, the diffraction angle β of the plus and minus first order diffracted lights is represented by the following equation when the diffractive optical element 101 is located in the atmosphere and the wavelength of light and the grating period are represented respectively by λ and Λ.

$$sin β = \frac{λ}{Λ} \qquad ( 1 )$$

Accordingly, by the three values of grating period Λ1, Λ2 and Λ3, the plus and minus first order diffracted lights with diffraction angles of the following three values.

$$sin {β}_{1} = \frac{λ}{{Λ}_{1}}$$

$$sin {β}_{2} = \frac{λ}{{Λ}_{2}}$$

$$sin {β}_{3} = \frac{λ}{{Λ}_{3}}$$

In the grating shown in FIG. 3, a ratio of grating ridge width to grating period and grating groove width to grating period are identical with each other for each value of grating period.

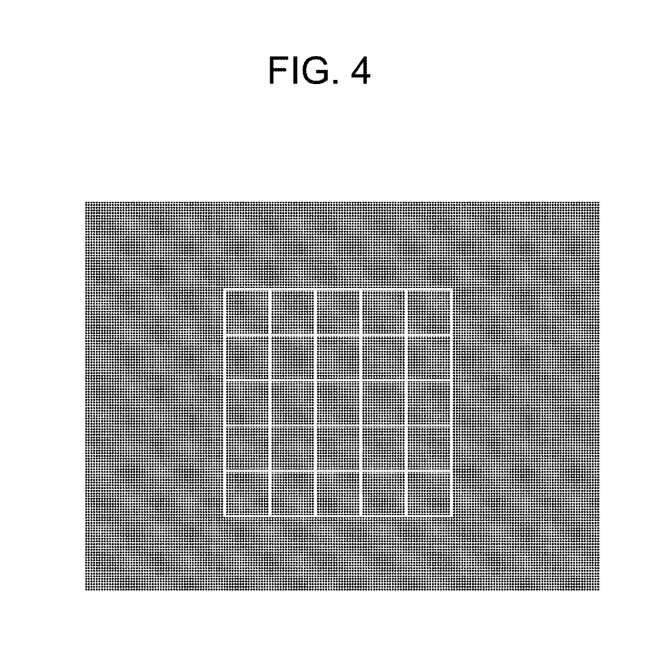

FIG. 4 shows an example of a diffraction image formed by the diffractive optical element 101 on the projection plane 103.

How to design the diffractive optical element 101 will be described below. An angle of the value that is double as great as the above-described diffraction angle β is referred to as angle of view and represented as θ. For example, assuming that a diffraction image with the angle of view of 90 degrees is obtained by the diffractive optical element 101 when the refractive index of the medium that the transmitted light travels, that is air, is 1.0 and the wavelength of light is 830 nanometers, Λ=1.17 micrometers can be obtained by substituting β=θ/2=45° to β of Equation (1). However, Equation (1) is an approximate expression in which distortion is not taken into account even when the angle of view is great, and therefore in order to obtain a more precise result, it is necessary to calculate the diffraction image using equation of Fresnel diffraction or Rayleigh-Sommerfeld equation. Λ=1.48 micrometers can be obtained using Rayleigh-Sommerfeld equation.

On the other hand, the period corresponding to the minimum interval (or minimum angle) between dots that form the above described diffraction image corresponds to the size of the diffractive optical element 101. For example, when a diffraction image with the angle of view of 90 degrees is formed by 500 dots arranged in a line, the angle between each pairs of adjacent dots is approximately 0.18 degrees. Accordingly, by substituting β=0.18° to β of Equation (1), Λ=263 micrometers can be obtained as the size of the diffractive optical element 101. The size of a pixel of the diffractive optical element 101 can be obtained using the size of the diffractive optical element 101 obtained above and the number of pixels of the bitmap file or another graphics file format. For example, when the number of pixels is 2048, the size of a pixel is approximately 0.129 micrometers.

In order to design a grating pattern on a plane surface of the diffractive optical element 101 shown in FIG. 2 such that a diffraction image shown in FIG. 4 as an example is formed, known design method such as interactive Fourier transformed method, Gerchberg-Saxton algorithm, and optimal angular rotation method (J. Bengtsson, Applied Optics, Vol. 36, No. 32, 8435 (1997)) can be used in a similar way to the way for computer-generated hologram that is a type of diffractive optical element.

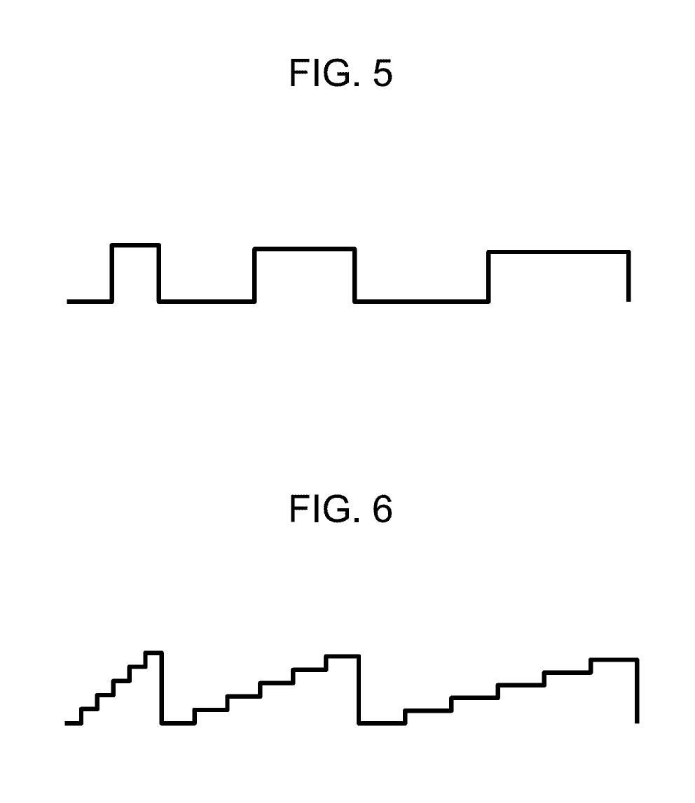

FIG. 5 is a conceptual diagram showing a cross section of a conventional diffraction grating in the direction in which the grating is aligned. The number N of levels of the grating is two.

FIG. 6 is a conceptual diagram showing a cross section of another conventional diffraction grating in the direction in which the grating is aligned. The number N of levels of the grating is six.

When the wavelength of light is represented as λ, the wave number is represented as k (k=2π/λ), the refractive index of the material of the grating is represented as n, the refractive index of the transmission medium (the medium surrounding the grating) is n₀ (where n>n₀) and the number of levels of the grating is N, a phase difference φ between the light travelling in the material of the grating and the light travelling in the medium surrounding the grating is given by the following equation provided that reflection loss incident to travel from the material to the medium is absent.

φ=nkh−n₀kh=(n−n₀)kh (2)

When the phase difference φ satisfies the following relationship, the wave of the light travelling in the material of the grating and the wave of the light travelling in the medium surrounding the grating cancel each other out, and intensity of the zeroth order light that is the portion of incident light, which travels in a straight line, that is, the zeroth order efficiency is minimized.

$$φ = ( n - {n}_{0} ) kh = 2 π \frac{N - 1}{N} \qquad ( 3 )$$

Accordingly, the height h of the grating that minimizes the zeroth order efficiency is given by the following equation.

$$h = \frac{N - 1}{N} \cdot \frac{λ}{n - {n}_{0}} \qquad ( 4 )$$

In the above, it is assumed that a ratio of grating ridge width to grating period and a ratio of width of a space occupied by the medium surrounding the grating, that is, of grating groove width to grating period is identical with each other.

Accordingly, the height of grating of a conventional diffractive optical element has been determined by Equation (4) so as to maximize efficiencies of the plus first and minus first order diffracted lights and to minimize the zeroth order light. Substituting N=2, λ=830 nanometers, n=1.4847, and n₀=1 in Equation (4) yields h=856 nanometers.

Zeroth order efficiency and diffraction efficiencies of a diffraction image generated by a diffractive optical element can be obtained by the rigorous coupled wave analysis (RCWA) that includes numerical operations of eigenvalues and boundary value problems of Maxwell equations of light wave, the finite difference time domain (FDTD) method in which the time component and the space component are divided by a grid and travel of light wave is analyzed by calculus of finite differences, and the like. It is desirable to handle the whole diffractive optical element as a single periodic structure in the numerical calculation. However, in consideration of loads of memories and high-speed operations of computers, it is also possible to calculate zeroth order efficiency and diffraction efficiencies for each portion of a periodic structure that forms the diffractive optical element, and then to obtain the result of the whole diffractive optical element by convolution integral.

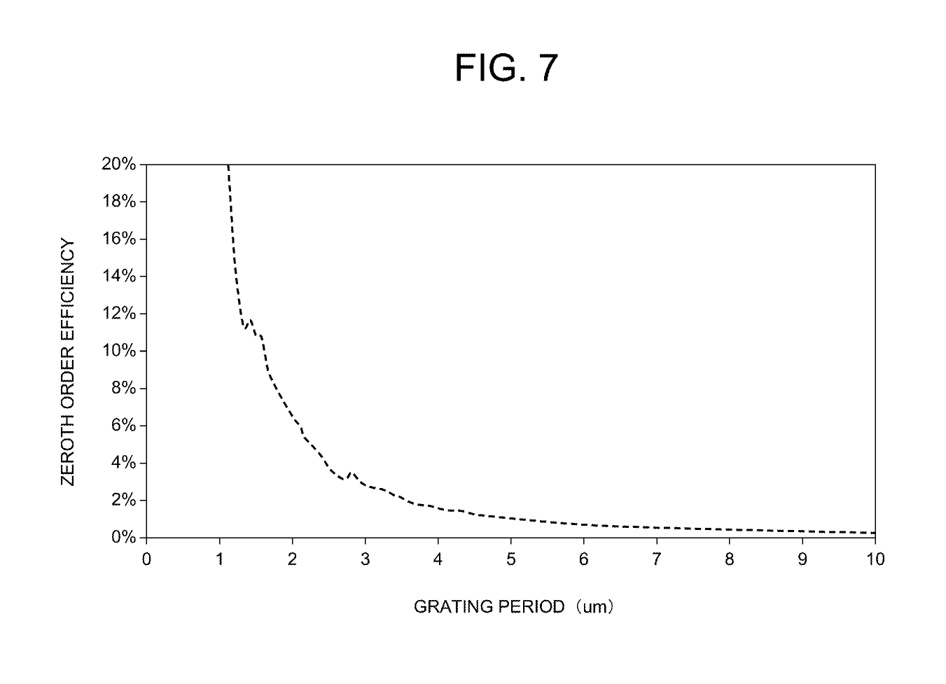

FIG. 7 shows a relationship between grating period and zeroth order efficiency of a conventional diffractive optical element. The relationship shown in FIG. 7 has been obtained by the above-described RCWA method. N=2, λ=830 nanometers, n=1.4847, and n₀=1, and the height of the grating obtained by Equation (4) is 856 nanometers. The horizontal axis of FIG. 7 indicates grating period. The unit of the horizontal axis is micrometer. The vertical axis of FIG. 7 indicates zeroth order efficiency. The unit of the vertical axis is percent. When grating period is 4 micrometers or greater, zeroth order efficiency is smaller than 2 percent. However, zeroth order efficiency is approximately 3 percent when grating period is 3 micrometers and is greater than 10 percent when grating period is 1.5 micrometers. Thus, zeroth order efficiency becomes greater when grating period is relatively small.

A potential reason why zeroth order efficiency becomes greater when grating period is relatively small is considered to be that zeroth order reflection efficiency becomes greater. Accordingly, a relationship between grating period and zeroth order reflection efficiency will be considered.

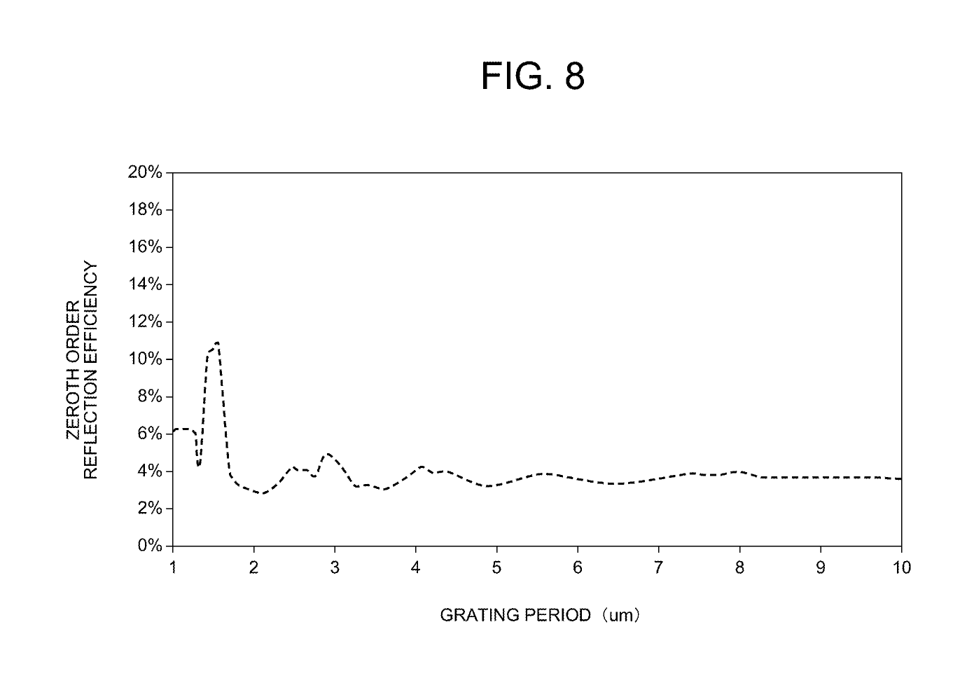

FIG. 8 shows a relationship between grating period and zeroth order reflection efficiency of the conventional diffractive optical element. The relationship shown in FIG. 8 has been obtained by the RCWA method. N=2, λ=830 nanometers, n=1.4847, and n₀=1, and the height of the grating obtained by Equation (4) is 856 nanometers. The horizontal axis of FIG. 8 indicates grating period. The unit of the horizontal axis is micrometer. The vertical axis of FIG. 8 indicates zeroth order reflection efficiency. The unit of the vertical axis is percent.

According to FIG. 8, zeroth order reflection efficiency oscillates with decrease in grating period when grating period is 6 micrometers or less and shows the peak value of 11 percent when grating period is approximately 1.6 micrometers. A potential reason for this is considered to be that zeroth order reflected light is generated by higher order reflected lights in the grating layer.

When the wavelength of light is represented as λ, the refractive index of the material of the grating is represented as n, an angle of incidence of ray is represented as α, and an order of diffraction is represented as m, a threshold period Λₗᵢₘᵢₜ for generation of higher order reflected light can be represented by the following equation.

$${Λ}_{lim it} = \frac{m λ}{n + n sin α} \qquad ( 5 )$$

Substituting λ=830 nanometers, n=1.4847, α=0, and m=3 in Equation (5) yields Λₗᵢₘᵢₜ=1.68 micrometers. Accordingly, the above-described peak value is considered to be caused by generation of the third order reflected light.

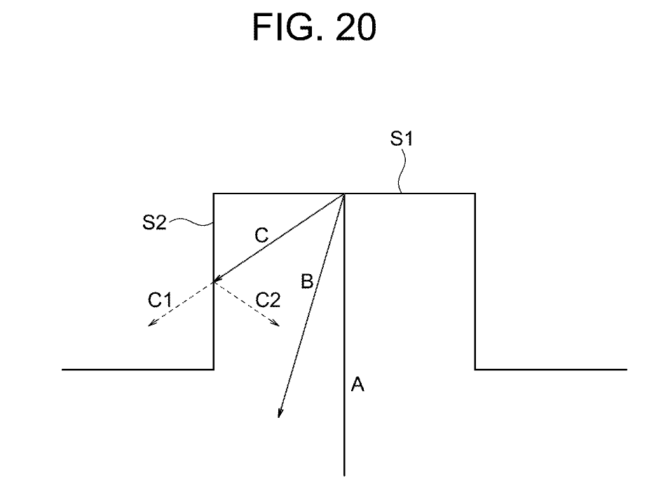

FIG. 20 illustrates behavior of higher order reflected light in a grating ridge. In FIG. 20 A represents incident light. B represents higher order reflected light with a smaller diffraction angle, and C represents higher order reflected light with a greater diffraction angle. The higher order reflected light with a greater diffraction angle reaches a side S2 of the grating ridge. A portion C1 of the higher order reflected light passes through the side S2 while another portion C2 is reflected by the side S2. The portion C2 forms zeroth order reflected light. Accordingly, zeroth order reflection efficiency increases with increase in diffraction angle of higher order reflected light.

Further, according to FIG. 8, zeroth order reflection efficiency is 4 percent or less and substantially invariant when grating period is greater than 6 micrometers. A reason why zeroth order reflection efficiency is substantially invariant in a range where grating period is relatively great is considered to be that in the region zeroth order reflection efficiency is substantially equal to the value that is determined by a difference in refractive index between air and the medium of the substrate (the material of the grating), and an influence of the grating structure is negligibly small.

Further, according to FIG. 8, zeroth order reflection efficiency decreases again when grating period becomes smaller than the threshold period Λₗᵢₘᵢₜ for generation of the third order reflected light. A reason for this is considered to be that grating period approaches the wavelength of light so that diffraction is not generated.

Thus, the increase in zeroth order efficiency in the range where grating period is relatively small is considered to be caused by the increase in zeroth order reflection efficiency. Accordingly, a phase difference caused by reflection is to be taken into consideration. Zeroth order reflection efficiency varies depending on grating period, and therefore a phase difference Δφ caused by reflection is a function of grating period Λ. The function can be represented by the following equation.

Δφ=Δφ(Λ)=(n−n₀)k·Δh(Λ) (6)

In the above, Δh(Λ) represents the optical path difference that corresponds to the phase difference Δφ.

When the effect of Equation (6) is taken into consideration in Equation (3), the following equation can be obtained. The reason why the phase difference Δφ caused by reflection has the minus sign is that the reflected light travels in the opposite direction from the transmitted light.

$${φ}^{′} = ( n - {n}_{0} ) {kh}^{′} - Δφ ( Λ ) = 2 π \frac{N - 1}{N}$$

In the above-described equation, phase that is adjusted in consideration of phase difference caused by reflection is represented as and height of grating that is adjusted in consideration of the phase difference caused by reflection is represented as h′. The following equation can be obtained by further transforming the above-described equation.

$${h}^{′} = \frac{N - 1}{N} \frac{λ}{n - {n}_{0}} + Δ h ( Λ ) = h + Δ h ( Λ ) \qquad ( 7 )$$

According to Equation (7), zeroth order reflection efficiency and zeroth order efficiency are expected to be reduced by increasing height of grating with respect to the value obtained by Equation (4), depending on grating period. That is, the height of grating that minimizes zeroth order reflection efficiency and zeroth order efficiency can be determined as a function of grating period.

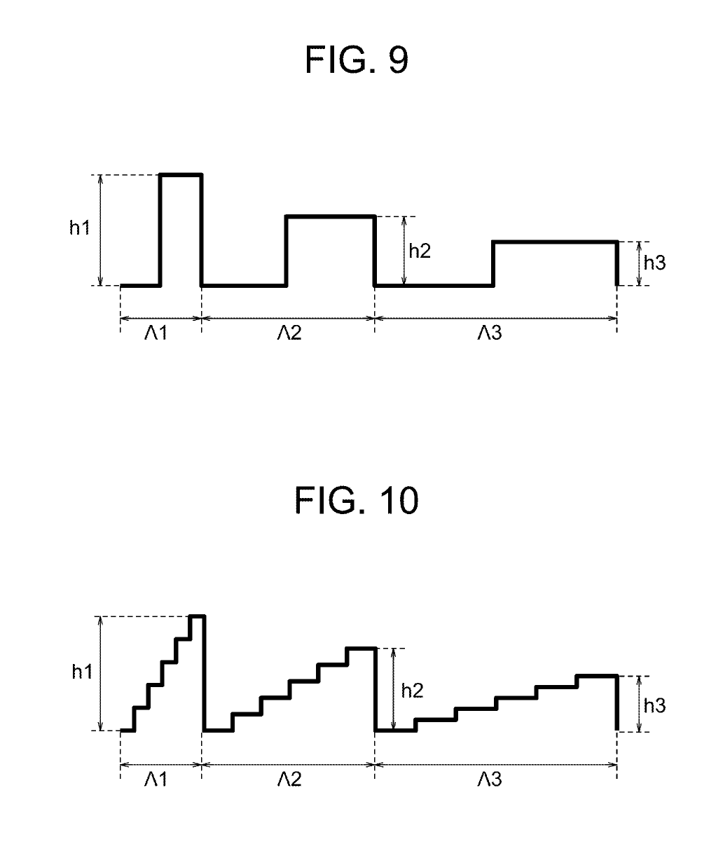

FIG. 9 is a conceptual diagram showing a cross section of a diffraction grating in a certain direction, height of the grating being changed according to grating period. The number of levels of the grating is 2.

FIG. 10 is another conceptual diagram showing a cross section of a diffraction grating in a certain direction, height of the grating being changed depending on grating period. The number of levels of the grating is 6.

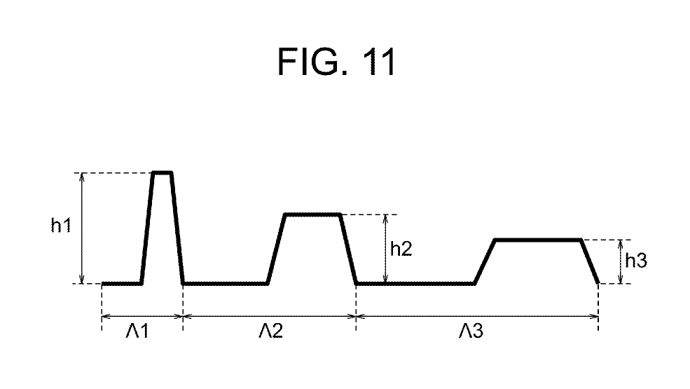

FIG. 11 is another conceptual diagram showing a cross section of a diffraction grating in a certain direction, height of the grating being changed depending on grating period. The number of levels of the grating is 2. In this embodiment, the shape of a grating ridge is not rectangular but trapezoidal. A trapezoidal-shaped cross section facilitates the manufacturing of grating.

Based on the above-described findings, height of grating that minimizes zeroth order efficiency is to be determined by the RCWA method for each grating period. Height of grating that minimizes zeroth order efficiency can be obtained with a known optimization method, in which calculations of the RCWA method are repeated. Examples in which height of grating is determined as described above will be described below. In the following examples, the shape of grating is rectangular, and the number of levels is 2 as shown in FIG. 9.

### EXAMPLE 1

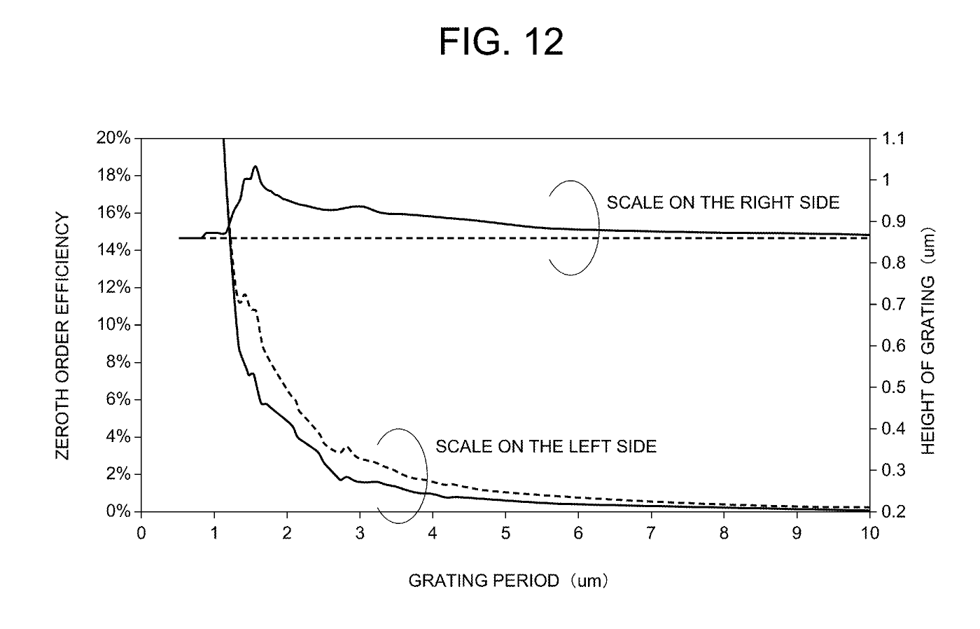

FIG. 12 shows relationships between grating period, zeroth order efficiency and height of grating of a diffractive optical element of Example 1. The results have been obtained by the RCWA method. N=2, λ=830 nanometers, n=1.4847, and n₀=1, and the height of the grating obtained by Equation (4) is 856 nanometers. The horizontal axis of FIG. 12 indicates grating period. The unit of the horizontal axis is micrometer. The vertical axes of FIG. 12 indicate zeroth order efficiency and height of grating. The unit of the vertical axis on the left side indicating zeroth order efficiency is percent. The unit of the vertical axis on the right side indicating height of grating is micrometer. The solid lines in FIG. 12 represent height h of grating adjusted so as to minimize zeroth order efficiency and zeroth order efficiency for the adjusted height h of grating. The dashed lines in FIG. 12 represent height h₀=856 nanometers of grating obtained by Equation (4) and zeroth order efficiency for the height h₀=856 nanometers. The adjusted height h of grating is substantially equal to h₀=856 nanometers when grating period is 10 micrometers. As grating period decreases, the adjusted height h of grating substantially monotonously increases except in some small sections, and height h of grating reaches the maximum value of 1030 nanometers at the threshold period Λₗᵢₘᵢₜ=1.68 micrometers for generation of the third order reflected light. As grating period further decreases, the adjusted height h of grating decreases and is equal to h₀=856 nanometers when grating period is Λ=830 meters or less. Around the threshold period Λₗᵢₘᵢₜ=1.68 micrometers for generation of the third order reflected light, zeroth order efficiency is approximately 6 percent for the adjusted height h of grating and is approximately 10 percent for height h₀=856 nanometers of grating. Thus, zeroth order efficiency has been reduced by the adjustment of height of grating.

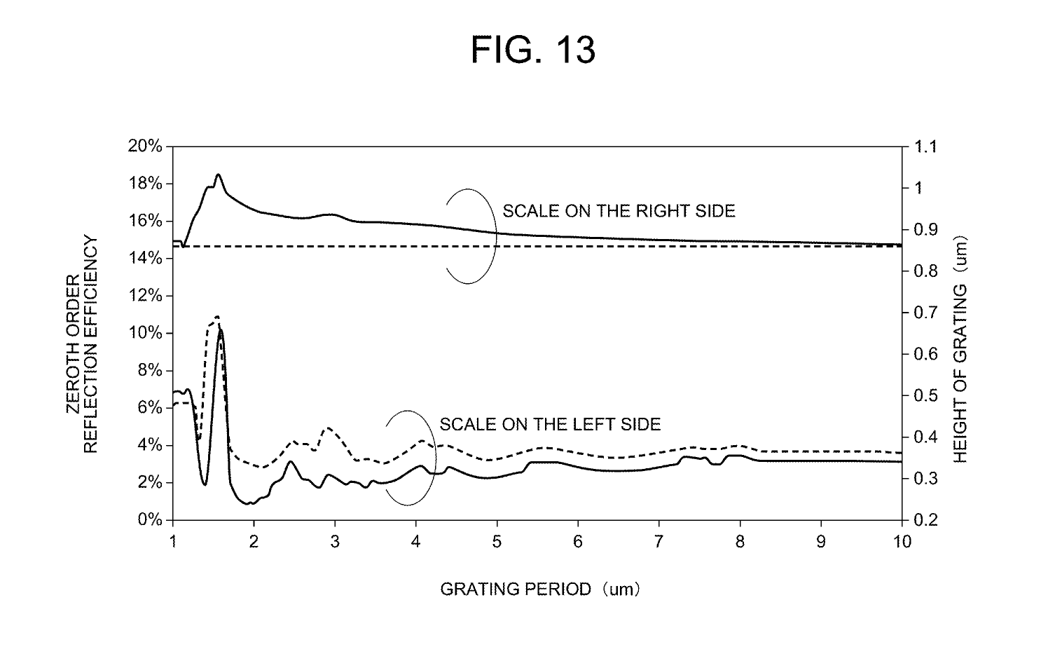

FIG. 13 shows relationships between grating period, zeroth order reflection efficiency and height of grating of the diffractive optical element of Example 1. The results have been obtained by the RCWA method. N=2, λ=830 nanometers, n=1.4847, and n₀=1, and the height of the grating obtained by Equation (4) is 856 nanometers. The horizontal axis of FIG. 13 indicates grating period. The unit of the horizontal axis is micrometer. The vertical axes of FIG. 13 indicate zeroth order reflection efficiency and height of grating. The unit of the vertical axis on the left side indicating zeroth order reflection efficiency is percent. The unit of the vertical axis on the right side indicating height of grating is micrometer. The solid lines in FIG. 13 represent height h of grating adjusted so as to minimize zeroth order efficiency and zeroth order reflection efficiency for the adjusted height h of grating. The dashed lines in FIG. 13 represent height h₀=856 nanometers of grating obtained by Equation (4) and zeroth order efficiency for the height h₀=856 nanometers. The adjusted height h of grating is equal to that shown in FIG. 12. Both zeroth order reflection efficiency for the height h₀ of grating and zeroth order reflection efficiency for the adjusted height h of grating oscillate, and the amplitude of the oscillation gradually becomes greater as grating period becomes smaller. For the height h₀ of grating, zeroth order reflection efficiency reaches the maximum value of approximately 11 percent around the threshold period Λₗᵢₘᵢₜ=1.68 micrometers for generation of the third order reflected light. For the adjusted height h, zeroth order reflection efficiency reaches the maximum value of approximately 10 percent around the threshold period Λₗᵢₘᵢₜ=1.68 micrometers for generation of the third order reflected light. For the adjusted height h, zeroth order reflection efficiency is approximately 0.9 percent while for the height h₀ of grating, zeroth order reflection efficiency is approximately 3 percent when grating period is 2 micrometers. Thus, zeroth order reflection efficiency has been reduced by the adjustment of height of grating. Accordingly, it is estimated that zeroth order reflection efficiency has been reduced by the adjustment of height of grating so that zeroth order efficiency also has been reduced.

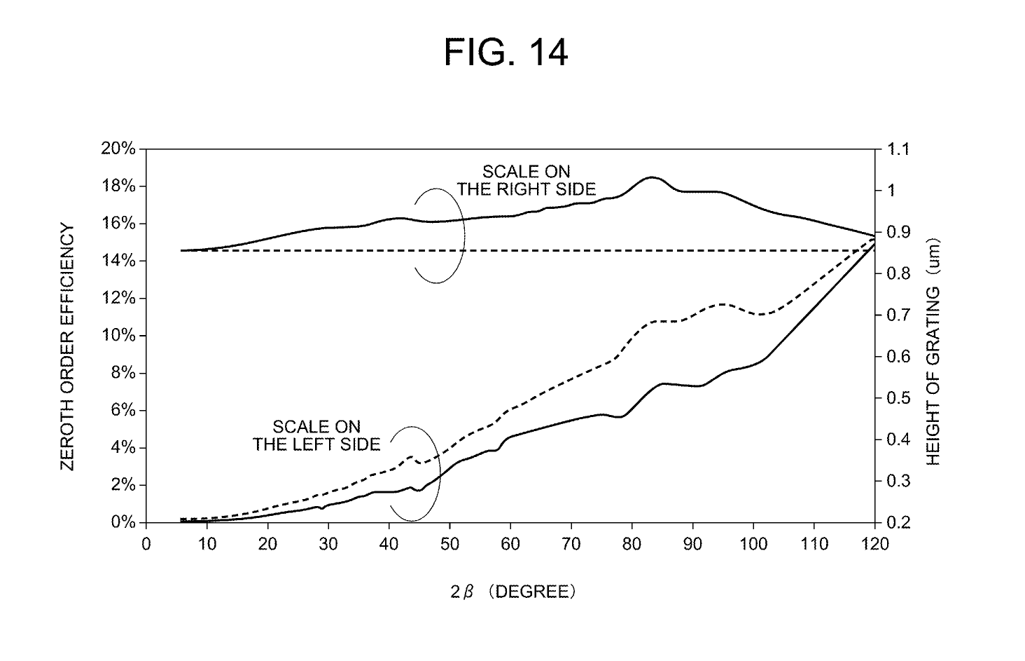

FIG. 14 shows relationships between diffraction angle, zeroth order efficiency and height of grating of the diffractive optical element of Example 1. In FIG. 14, the horizontal axis indicating grating period in FIG. 12 has been replaced with the horizontal axis indicating diffraction angle. The unit of the horizontal axis is degree. The vertical axes of FIG. 14 indicate zeroth order efficiency and height of grating. The unit of the vertical axis on the left side indicating zeroth order efficiency is percent. The unit of the vertical axis on the right side indicating height of grating is micrometer. The solid lines in FIG. 14 represent height h of grating adjusted so as to minimize zeroth order efficiency and zeroth order efficiency for the adjusted height h of grating. The dashed lines in FIG. 14 represent height h₀=856 nanometers of grating obtained by Equation (4) and zeroth order efficiency for the height h₀=856 nanometers. The adjusted height h of grating is substantially equal to h₀=856 nanometers when 2β is 5 degrees. As 2β increases, the adjusted height h of grating substantially monotonously increases except in some small sections, and the adjusted height h of grating reaches the maximum value of 1030 nanometers when 2β=83 degrees. As 2β further increases, the adjusted height h of grating decreases and is approximately 0.9 micrometers when 2β=120 degrees. When 2β is around 83 degrees, zeroth order efficiency is approximately 6 percent for the adjusted height h of grating and is approximately 10 percent for the height h₀=856 nanometers of grating. Thus, zeroth order efficiency has been reduced by the adjustment of height of grating.

To minimize zeroth order efficiency by changing a ratio F of grating groove width to grating period instead of changing height of grating will be considered below.

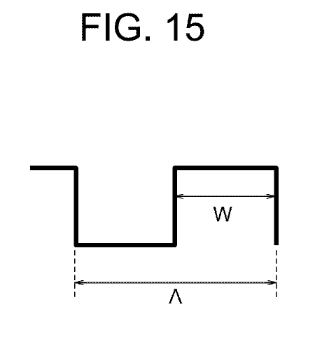

FIG. 15 is a section view of a grating for illustrating a ratio F of grating groove width to grating period. In FIG. 15, grating ridge width is represented as W, and therefore a ratio F of grating groove width to grating period can be represented by the following equation.

F=1−W/Λ

In Example 1, the ratio F of the grating remains invariant independently of grating period and is 0.5. The constant ratio F can be determined in the range from 0.4 to 0.7.

An example in which the ratio F is changed depending on grating period so as to minimize zeroth order efficiency will be described below. The ratio F that minimizes zeroth order efficiency can be obtained with a known optimization method, in which calculations of the RCWA method are repeated. That is, the ratio F that minimizes zeroth order efficiency can be determined as a function of grating period.

### EXAMPLE 2

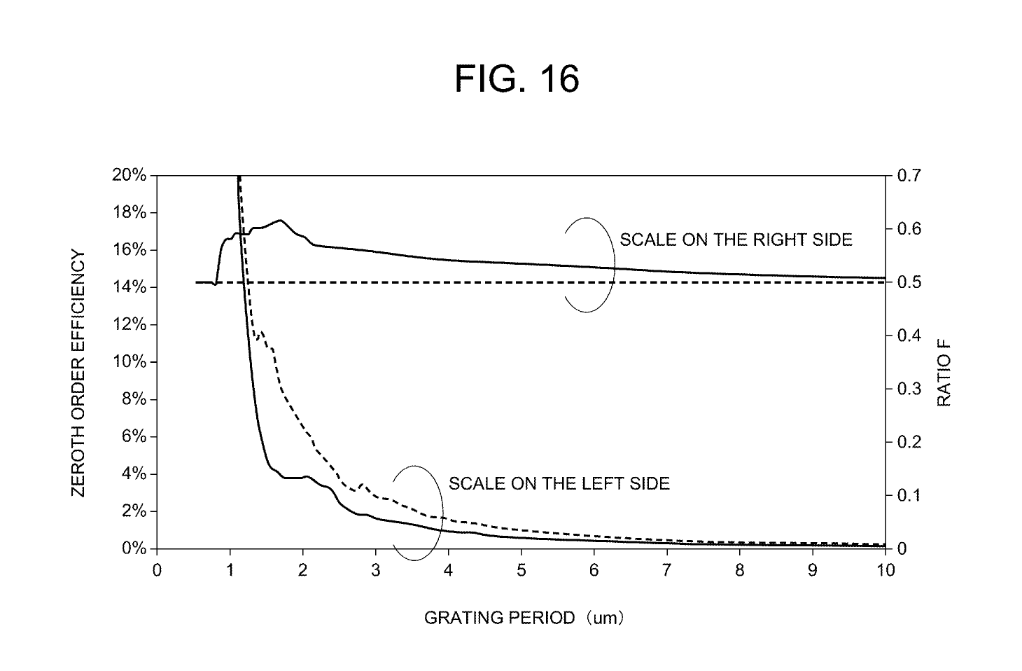

FIG. 16 shows relationships between grating period, zeroth order efficiency and ratio F of a diffractive optical element of Example 2. The results have been obtained by the RCWA method. N=2, λ=830 nanometers, n=1.4847, and n₀=1, and the height of the grating obtained by Equation (4) is h₀=856 nanometers. The horizontal axis of FIG. 16 indicates grating period. The unit of the horizontal axis is micrometer. The vertical axes of FIG. 16 indicate zeroth order efficiency and ratio F. The unit of the vertical axis on the left side indicating zeroth order efficiency is percent. The solid lines in FIG. 16 represent ratio F adjusted so as to minimize zeroth order efficiency and zeroth order efficiency for the adjusted ratio F. The dashed lines in FIG. 16 represent the ratio F₀ that is invariant independently of grating period and zeroth order efficiency for the ratio F₀. The ratio F₀ that is invariant independently of grating period is 0.5. The adjusted ratio F indicated by the solid line is approximately 0.5 when grating period is 10 micrometers. As grating period decreases, the adjusted ratio F indicated by the solid line monotonously increases except in some small sections, and it reaches the maximum value of 0.61 at the threshold period Λₗᵢₘᵢₜ=1.68 micrometers for generation of the third order reflected light. As grating period further decreases, the ratio F indicated by the solid line decreases and is equal to 0.5 when grating period is Λ=830 meters or less. Around the threshold period Λₗᵢₘᵢₜ=1.68 micrometers for generation of the third order reflected light, zeroth order efficiency is approximately 4 percent for the ratio F that has been adjusted and is approximately 11 percent for ratio F₀=3.5. Thus, zeroth order efficiency has been reduced by the adjustment of ratio F.

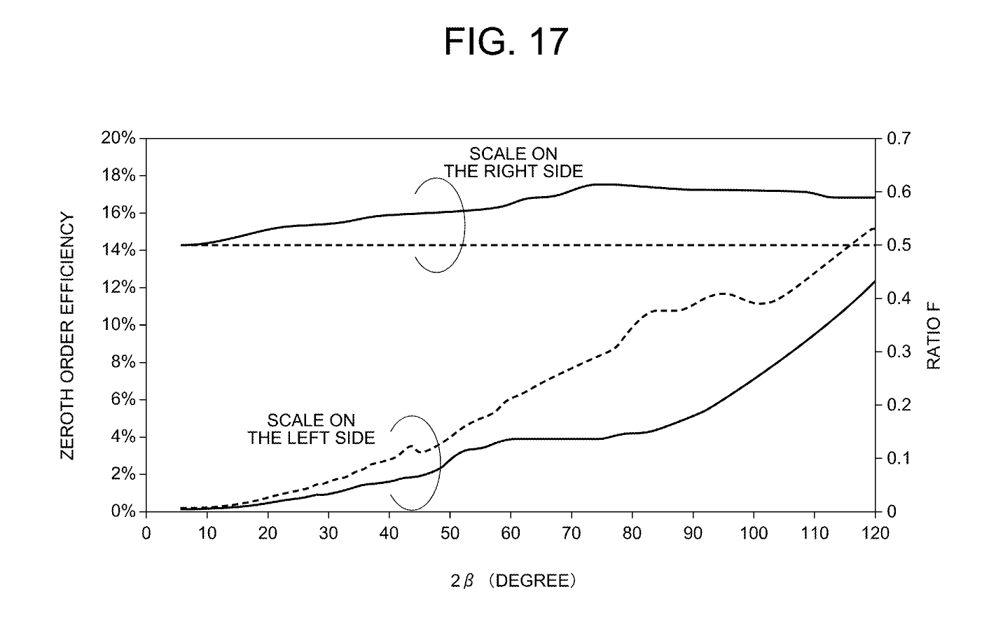

FIG. 17 shows relationships between diffraction angle, zeroth order efficiency and ratio F of the diffractive optical element of Example 2. Diffraction angle is represented by 2β that is twice as great as 8. In FIG. 17, the horizontal axis indicating grating period in FIG. 16 has been replaced with the horizontal axis indicating diffraction angle. The vertical axes of FIG. 17 indicate zeroth order efficiency and ratio F. The unit of the vertical axis on the left side indicating zeroth order efficiency is percent. The vertical axis on the right side indicates ratio F. The solid lines in FIG. 17 represent ratio F adjusted so as to minimize zeroth order efficiency and zeroth order efficiency for the adjusted ratio F. The dashed lines in FIG. 17 represent a ratio F₀ that is invariant independently of grating period and zeroth order efficiency for the ratio F₀=0.5. The ratio F indicated by the solid line is approximately 0.5 when 2β is 5 degrees. As 2β increases, the ratio F indicated by the solid line monotonously increases except in some small sections, and it reaches the maximum value of 0.61 at 2β=75 degrees. As 2β further decreases, ratio F indicated by the solid line decreases and is equal to approximately 0.6 when 2β=120 degrees. Around 2β=75 degrees, zeroth order efficiency is approximately 4 percent for the ratio F that has been adjusted and is approximately 8 percent for the ratio F₀=0.5. Thus, zeroth order efficiency has been reduced by the adjustment of ratio F.

The value of height of grating that is kept constant may be determined such that it is in the range from 0.8h₀ to 2h₀.

An example in which two values of ratio F are determined depending on grating period, and under the conditions height of grating is changed such that zeroth order efficiency is minimized will be described below.

### EXAMPLE 3

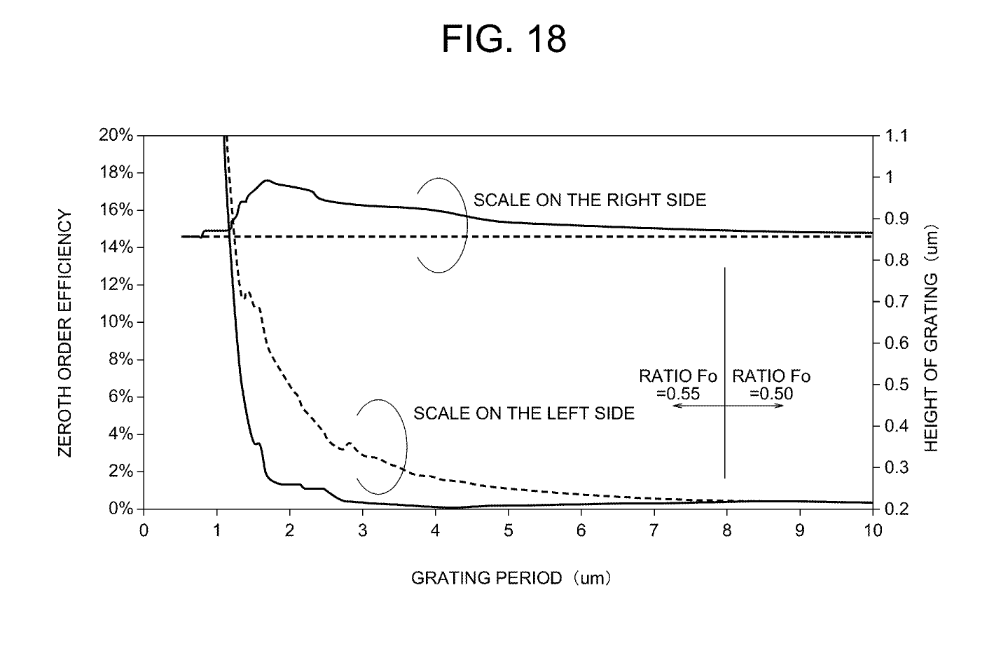

FIG. 18 shows relationships between grating period, zeroth order efficiency and height of grating of a diffractive optical element of Example 3. The results have been obtained by the RCWA method. N=2, λ=830 nanometers, n=1.4847, and n₀=1, and the height of the grating obtained by Equation (4) is h₀=856 nanometers. The horizontal axis of FIG. 18 indicates grating period. The unit of the horizontal axis is micrometer. The vertical axes of FIG. 18 indicate zeroth order efficiency and height of grating. The unit of the vertical axis on the left side indicating zeroth order efficiency is percent. The unit of the vertical axis on the right side indicating height of grating is micrometer. The value of ratio F is set to 0.55 when grating period is less than 8 micrometers and to 0.5 when grating period is 8 micrometers or more. The solid lines in FIG. 18 represent height h of grating adjusted so as to minimize zeroth order efficiency and zeroth order efficiency for the adjusted height h of grating. The dashed lines in FIG. 18 represent height h₀=856 nanometers of grating obtained by Equation (4) and zeroth order efficiency for the height h₀=856 nanometers. The adjusted height h of grating is substantially equal to h₀=856 nanometers when grating period is 10 micrometers. As grating period decreases, the adjusted height h of grating represented by a solid line substantially monotonously increases except in some small sections, and adjusted height h of grating reaches the maximum value of 990 nanometers at the threshold period Λₗᵢₘᵢₜ=1.68 micrometers for generation of the third order reflected light. As grating period further decreases, height h of grating represented by the solid line decreases and is equal to h₀=856 nanometers when grating period is Λ=830 meters or less. Around the threshold period Λₗᵢₘᵢₜ=1.68 micrometers for generation of the third order reflected light, zeroth order efficiency is less than 2 percent for the adjusted height h of grating represented by the solid line and is approximately 8 percent for the height h₀=856 nanometers of grating. Thus, zeroth order efficiency has been reduced to a smaller value by the adjustment of both height of grating and ratio F than the values obtained by the adjustment of either one of them.

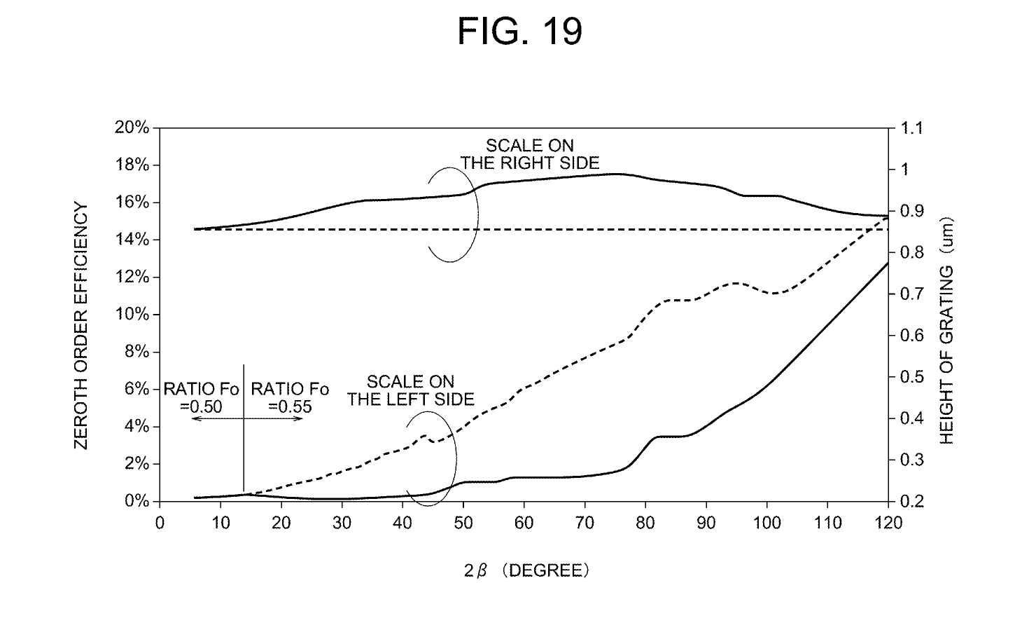

FIG. 19 shows relationships between diffraction angle, zeroth order efficiency and ratio F of the diffractive optical element of Example 3. Diffraction angle is represented by 2β that is twice as great as β. In FIG. 19, the horizontal axis indicating grating period in FIG. 18 has been replaced with the horizontal axis indicating diffraction angle. The horizontal axis indicates 2β. The unit of the horizontal axis is degree. The vertical axes of FIG. 19 indicate zeroth order efficiency and height of grating. The unit of the vertical axis on the left side indicating zeroth order efficiency is percent. The unit of the vertical axis on the right side indicating height of grating is micrometer. The value of ratio F is set to 0.5 when 2β is 15 degrees or less and to 0.55 when 2β is greater than15 degrees. The solid lines in FIG. 19 represent height h of grating adjusted so as to minimize zeroth order efficiency and zeroth order efficiency for the adjusted height h of grating. The dashed lines in FIG. 17 represent height h₀=856 nanometers of grating that is invariant independently of grating period and zeroth order efficiency for the height h₀=856 nanometers of grating. The adjusted height h of grating indicated by a solid line is substantially equal to h₀=856 nanometers when 2β is 5 degrees. As 2β increases, the adjusted height h of grating indicated by the solid line monotonously increases except in some small sections, and it reaches the maximum value of 990 nanometers at 2β=75 degrees. As 2β further increases, the adjusted height h of grating indicated by the solid line decreases and is equal to approximately 900 nanometers when 2β=120 degrees. Around 2β=75 degrees, zeroth order efficiency is less than 2 percent for the adjusted height h of grating that has been adjusted and is indicated by the solid line and is approximately 8 percent for the height h₀ of grating. Thus, zeroth order efficiency has been reduced by the adjustment of ratio F. Thus, zeroth order efficiency has been reduced to a smaller value by the adjustment of both height of grating and ratio F than the values obtained by the adjustment of either one of them.

### Summary of Performance of Diffractive Optical Elements of Examples 1 to 3

Table 1 summarizes performance figures of the diffractive optical elements of Examples 1 to 3. According to Equation (5), the threshold period Λ₃ for generation of the third order reflected light, the threshold period Λ₅ for generation of the fifth order reflected light and the threshold period Λ₇ for generation of the seventh order reflected light are respectively 1.68 micrometers, 2.8 micrometers and 3.9 micrometers. Since a threshold period is a lower limit value of grating period, it is also referred to as a lower limit period.

TABLE 1

| | Example 1 | Example 2 | Example 3 | Conventional |
|---|---|---|---|---|
| h at Λ₃ | 1.20 | 1 | 1.16 | 1 |
| h for Λ₃-Λ₅ (hav1) | 1.09 | 1 | 1.10 | 1 |
| h for Λ₅-Λ₇ (hav2) | 1.06 | 1 | 1.06 | 1 |
| F at Λ₃ | 0.5 | 0.61 | 0.55 | 0.5 |
| F for Λ₃-Λ₅ (Fav1) | 0.5 | 0.56 | 0.55 | 0.5 |
| F for Λ₅-Λ₇ (Fav2) | 0.5 | 0.54 | 0.55 | 0.5 |
| Zeroth order | 5.7% | 4.2% | 2.2% | 9.1% |
| efficiency for Λ₃ | | | | |
| Zeroth order | 1.9% | 1.9% | 0.34% | 3.5% |
| efficiency forΛ₃-Λ₅ | | | | |
| Zeroth order | 1.0% | 1.0% | 0.12% | 1.7% |
| efficiency forΛ₅-Λ₇ | | | | |

In Table 1, h represents height of grating, and F represents a ratio of grating groove width to grating period. Height h of grating is represented as a ratio of that to the value obtained by Equation (4), that is, h₀=856 nanometers. The unit of zeroth order efficiency is percent.

In Example 1, the ratio of height h of grating to h₀ is 1 or more. The ratio of height h of grating to h₀ reaches the maximum value 1.20 at Λ₃. Accordingly, the following relationships are satisfied.

$$\frac{N - 1}{N} \cdot \frac{λ}{\vert n - {n}_{0} \vert} \leq h \leq h max$$

$$1.1 \cdot \frac{N - 1}{N} \cdot \frac{λ}{\vert n - {n}_{0} \vert} \leq h max \leq 2 \cdot \frac{N - 1}{N} \frac{λ}{\vert n - {n}_{0} \vert}$$

In Example 1, the ratio F is invariant independently of grating period and is 0.5. Accordingly, the following relationship is satisfied.

0.5≦F≦0.7

Further, when an average value of height of grating in the range of grating period that is greater than the lower limit period Λ₃ for generation of the third order reflected light and is equal to or smaller than the lower limit period Λ₅ for generation of the fifth order reflected light is represented as hav1, and an average value of height of grating in the range of grating period that is greater than the lower limit period Λ₅ for generation of the fifth order reflected light and is equal to or smaller than the lower limit period Λ₇ for generation of the seventh order reflected light is represented as hav2, the following relationships are satisfied.

$$\frac{N - 1}{N} \cdot \frac{λ}{\vert n - {n}_{0} \vert} < hav 2 < hav 1 < h max$$

$$0.03 \cdot \frac{N - 1}{N} \cdot \frac{λ}{\vert n - {n}_{0} \vert} \leq ( h max - hav 1 )$$

In Example 1, zeroth order efficiency at Λ₃ is 5.7 percent and is reduced by 3.4 percent in comparison with the conventional case. In Example 1, an average value of zeroth order efficiency in the range of grating period that is greater than the lower limit period Λ₃ for generation of the third order reflected light and is equal to or smaller than the lower limit period As for generation of the fifth order reflected light is 1.9 percent and is reduced by 1.6 percent in comparison with the conventional case. In Example 1, an average value of zeroth order efficiency in the range of grating period that is greater than the lower limit period Λ₅ for generation of the fifth order reflected light and is equal to or smaller than the lower limit period Λ₇ for generation of the seventh order reflected light is 1.0 percent and is reduced by 0.7 percent in comparison with the conventional case.

In Example 2, the ratio of height h of grating to h₀ is invariant independently of grating period and is 1. Accordingly, the following relationship is satisfied.

$$\frac{N - 1}{N} \cdot \frac{λ}{\vert n - {n}_{0} \vert} \leq h \leq 2 \cdot \frac{N - 1}{N} \cdot \frac{λ}{\vert n - {n}_{0} \vert}$$

In Example 2, the ratio F is equal to or greater than 0.5. The ratio F reaches the maximum value 0.61 at Λ₃. Accordingly, the following relationships are satisfied.

0.5≦F≦F max

0.55≦F max≦0.7

Further, when an average value of ratio F in the range of grating period that is greater than the lower limit period Λ₃ for generation of the third order reflected light and is equal to or smaller than the lower limit period Λ₅ for generation of the fifth order reflected light is represented as Fav1, and an average value of ratio F in the range of grating period that is greater than the lower limit period Λ₅ for generation of the fifth order reflected light and is equal to or smaller than the lower limit period Λ₇ for generation of the seventh order reflected light is represented as Fav2, the following relationships are satisfied.

0.5<Fav2<Fav1<F max

0.03≦(F max−Fav1)

In Example 2, zeroth order efficiency at Λ₃ is 4.2 percent and is reduced by 4.9 percent in comparison with the conventional case. In Example 2, an average value of zeroth order efficiency in the range of grating period that is greater than the lower limit period Λ₃ for generation of the third order reflected light and is equal to or smaller than the lower limit period Λ₅ for generation of the fifth order reflected light is 1.9 percent and is reduced by 1.6 percent in comparison with the conventional case. In Example 2, an average value of zeroth order efficiency in the range of grating period that is greater than the lower limit period As for generation of the fifth order reflected light and is equal to or smaller than the lower limit period Λ₇ for generation of the seventh order reflected light is 1.0 percent and is reduced by 0.7 percent in comparison with the conventional case.

In Example 3, the ratio of height h of grating to h₀ is 1 or more. The ratio of height h of grating to h₀ reaches the maximum value 1.16 at Λ₃. Accordingly, the following relationships are satisfied.

$$\frac{N - 1}{N} \cdot \frac{λ}{\vert n - {n}_{0} \vert} \leq h \leq h max$$

$$1.1 \cdot \frac{N - 1}{N} \cdot \frac{λ}{\vert n - {n}_{0} \vert} \leq h max \leq 2 \cdot \frac{N - 1}{N} \frac{λ}{\vert n - {n}_{0} \vert}$$

In Example 3, the ratio F is 0.55 when grating period is less than 8 micrometers, and is 0.5 when grating period is 8 micrometers or more. Accordingly, the following relationship is satisfied.

0.5≦F≦0.7

Further, when an average value of height of grating in the range of grating period that is greater than the lower limit period Λ₃ for generation of the third order reflected light and is equal to or smaller than the lower limit period Λ₅ for generation of the fifth order reflected light is represented as hav1, and an average value of height of grating in the range of grating period that is greater than the lower limit period Λ₅ for generation of the fifth order reflected light and is equal to or smaller than the lower limit period Λ₇ for generation of the seventh order reflected light is represented as hav2, the following relationships are satisfied.

$$\frac{N - 1}{N} \cdot \frac{λ}{\vert n - {n}_{0} \vert} < hav 2 < hav 1 < h max$$

$$0.03 \cdot \frac{N - 1}{N} \cdot \frac{λ}{\vert n - {n}_{0} \vert} \leq ( h max - hav 1 )$$

In Example 3, zeroth order efficiency at Λ₃ is 2.2 percent and is reduced by 6.9 percent in comparison with the conventional case. In Example 3, an average value of zeroth order efficiency in the range of grating period that is greater than the lower limit period Λ₃ for generation of the third order reflected light and is equal to or smaller than the lower limit period Λ₅ for generation of the fifth order reflected light is 0.34 percent and is reduced by 3.16 percent in comparison with the conventional case. In Example 3, an average value of zeroth order efficiency in the range of grating period that is greater than the lower limit period Λ₅ for generation of the fifth order reflected light and is equal to or smaller than the lower limit period Λ₇ for generation of the seventh order reflected light is 0.12 percent and is reduced by 1.58 percent in comparison with the conventional case.

What is claimed is:

1. A diffractive optical element that forms a predetermined image with a parallel light beam at a predetermined angle of incidence and that has a grating having plural values of grating period,
wherein at least one of height of the grating and a ratio of grating groove width to grating period is changed as a function of grating period such that zeroth order efficiency is reduced.

2. A diffractive optical element according to claim 1, wherein the grating has N levels, N being an integer that is 2 or more, and height h of the grating is changed as a function of grating period, and when wavelength of the light is represented as λ, the maximum value of h is represented as hmax, refractive index of the material of the grating is represented as n, and refractive index of the medium surrounding the grating is represented as n₀,
$$\frac{N - 1}{N} \cdot \frac{λ}{\vert n - {n}_{0} \vert} \leq h \leq h max$$
$$and$$
$$1.1 \cdot \frac{N - 1}{N} \cdot \frac{λ}{\vert n - {n}_{0} \vert} \leq h max \leq 2 \cdot \frac{N - 1}{N} \frac{λ}{\vert n - {n}_{0} \vert}$$
are satisfied.

3. A diffractive optical element according to claim 2, wherein when an average value of height of the grating in the range of grating period that is greater than the lower limit period for generation of the third order reflected light and is equal to or smaller than the lower limit period for generation of the fifth order reflected light is represented as hav1, and an average value of height of the grating in the range of grating period that is greater than the lower limit period for generation of the fifth order reflected light and is equal to or smaller than the lower limit period for generation of the seventh order reflected light is represented as hav2,
$$\frac{N - 1}{N} \cdot \frac{λ}{\vert n - {n}_{0} \vert} < hav 2 < hav 1 < h max$$
is satisfied.

4. A diffractive optical element according to claim 3, wherein
$$0.03 \cdot \frac{N - 1}{N} \cdot \frac{λ}{\vert n - {n}_{0} \vert} \leq ( h max - hav 1 )$$
is satisfied.

5. A diffractive optical element according to claim 1, wherein when a ratio of grating groove width to grating period is represented as F,
0.4≦F≦0.7
is satisfied.

6. A diffractive optical element according to claim 1, wherein when a ratio of width of grating groove to grating period is represented as F and the maximum value of F is represented as Fmax, F is changed as a function of grating period, and
0.5≦F≦F max
and
0.55≦F max≦0.7
are satisfied.

7. A diffractive optical element according to claim 6, wherein when an average value of a ratio of grating groove width to grating period in the range of grating period that is greater than the lower limit period for generation of the third order reflected light and is equal to or smaller than the lower limit period for generation of the fifth order reflected light is represented as Fav1, and an average value of a ratio of grating groove width to grating period in the range of grating period that is greater than the lower limit period for generation of the fifth order reflected light and is equal to or smaller than the lower limit period for generation of the seventh order reflected light is represented as Fav2,
0.5<Fav2<Fav1<F max
is satisfied.

8. A diffractive optical element according to claim 7, wherein
0.03≦(F max−Fav1)
is satisfied.

9. A diffractive optical element according to claim 6, wherein the grating has N levels, N being an integer that is 2 or more, and when wavelength of the light is represented as λ, refractive index of the material of the grating is represented as n, refractive index of the medium surrounding the grating is represented as n₀ and height of the grating is represented as h,
$$0.8 \cdot \frac{N - 1}{N} \cdot \frac{λ}{\vert n - {n}_{0} \vert} \leq h \leq 2 \cdot \frac{N - 1}{N} \cdot \frac{λ}{\vert n - {n}_{0} \vert}$$
is satisfied.
